(19) United States
(12) Patent Application Publication
(10) Pub. No.: US 2023/0246809 A1
(43) Pub. Date: Aug. 3, 2023

(54) PROCESSING MODULE FOR AUTHENTICATING A COMMUNICATION DEVICE IN A 3G CAPABLE NETWORK

(71) Applicant: VODAFONE IP LICENSING LIMITED, Newbury, Berkshire (GB)

(72) Inventors: Sophie Nicole BOURNE, Newbury, Berkshire (GB); Stephen Hugh BABBAGE, Newbury, Berkshire (GB)

(21) Appl. No.: 17/904,281

(22) PCT Filed: Feb. 8, 2021
(86) PCT No.: PCT/GB2021/050276

§ 371 Date: Aug. 15, 2022

(30) Foreign Application Priority Data
Feb. 14, 2020 (GB) 2002067.3

(51) Int. Cl. H04L 9/06

(52) U.S. Cl. CPC H04L 9/0618; H04L 2209/80

(57) ABSTRACT

A processing module for a communication device comprises memory for storing a key; and one or more processing elements coupled to the memory. The one or more processing elements are configured to: receive a current sequence number and a random number provided by a network entity; determine whether a value of the current sequence number is within a range determined by reference to a value of a previously received sequence number stored in the memory. When the value of the current sequence number is not within the range determined by reference to the value of the previously received sequence number, the one or more processing elements are configured to: generate a sequence number encryption key derived from the random number and the key stored in the memory, the sequence number encryption key having a length greater than 48 bits; encrypt using a block cipher encryption function, the previously received sequence number with the sequence number encryption key to provide an encrypted sequence number, wherein the block cipher encryption function is configured to generate the encrypted sequence number having the same number of bits as the previously received sequence number; provide the encrypted sequence number for sending in a response message to the network entity. A communication device, a communication system and a method are also disclosed.

### FIELD OF THE DISCLOSURE

This disclosure relates to a processing module for a communication device and a method. More particularly, this disclosure relates to a method, performed in a processing module of a communication device, for generating an encrypted sequence number for a response message to a network entity, for example, as part of an authentication protocol.

### BACKGROUND OF THE DISCLOSURE

In order to provide security features and security mechanisms for communication systems (e.g. 3^{rd} Generation (3G), 4^{th} Generation (4G) and 5^{th} Generation (5G) systems), the 3^{rd} Generation Partnership Project (3GPP) group has defined an authentication mechanism or protocol for mutually authenticating a communication device equipped with a Universal Subscriber Identity Module (USIM) application (e.g. implemented on a card such as a Universal Integrated Circuit Card (UICC)) with networks, and establishing keys to protect subsequent communications between the communication device and the networks. The authentication mechanism is known as the Authentication and Key Agreement (AKA) protocol.

The 3G AKA protocol is described in the 3GPP technical specification 3GPP TS 33.102 V15.1.0 (2018-12), which defines 3G security procedures performed within 3G capable networks e.g. intra-UMTS and UMTS-GSM.

The 3G AKA protocol is a challenge-response protocol and uses a 48-bit sequence number (SQN) to make sure the authentication challenges are ‘fresh’ to prevent an attacker from recording and replaying the authentication challenge. An authentication challenge (known as an authentication vector) created by an Authentication Centre (AuC) within the Home Subscriber Server (HSS) or Home Location Register (HLR) in the home network is sent to the USIM of the communication device. The communication device replies with an authentication response message when the authentication challenge is successfully received and verified by the USIM or an authentication failure message with the cause of failure otherwise when verification is not successful. Typically, the AuC will just increase the SQN by one each time it sends an authentication vector.

If an eavesdropper could see the SQN values in authentication vectors being sent to a particular USIM, the eavesdropper could follow the gradual increase in SQN value, and probably tell that it was the same USIM. This could be used to track the whereabouts and activity of a user (or subscriber). The SQN sent in the authentication vector is therefore concealed by being masked by an Anonymity Key (AK) which has the same length as SQN (i.e. 48 bits) and which is freshly generated each time. The AK is cryptographically derived from two inputs: a unique key K for the user (also referred to as subscriber), which is stored in both the USIM and the AuC; and RAND, a random value freshly generated by the AuC for each new authentication vector. RAND is included in the authentication vector, so the USIM has everything it needs to generate the same Anonymity Key and unmask the SQN in the received authentication vector.

The authentication vector sent to the USIM includes a masked SQN, a RAND and a Message Authentication Code (MAC) supplied by the AuC. The USIM verifies the masked SQN, RAND and MAC supplied by the AuC. To verify the masked SQN, the USIM unmasks the masked SQN and checks whether the received SQN of the received authentication vector is new (i.e. fresh). When the USIM determines that the received SQN is new, the USIM accepts the received SQN and stores the received SQN and the communication device replies with an authentication response message when the authentication is successful. When the USIM determines that the received SQN is not new (e.g. is too low compared to the SQNs received before) or otherwise suspicious (e.g. it may be too high as well as too low) but the authentication challenge is correct in all other respects, the USIM rejects the received authentication vector and sends a synchronisation failure message (or resync message) back to the home network. In other words, a resync message is sent by the USIM when the USIM determines that synchronisation of the SQN between the AuC and the USIM is lost. The received SQN may be too low in the event of accidental reset of the HLR or HSS (where all SQN values are reset to 0) or a change in HLR/HSS (e.g. migration between HLRs or fallover to a difference HLR instance in a load-balanced network). The received SQN may be too high if a communication device has been detached from a network for a long period of time and the HLR/HSS has generated a large number of authentication vectors in the interval.

The resync message includes the highest corresponding SQN value that the USIM has previously accepted (this will be referred to hereinafter as SQN_{MS}, where MS stands for Mobile Station). On receipt at the home network, the AuC can then update its stored SQN value accordingly, so that future SQN values it creates for authentication vectors will be accepted by the USIM. For security, SQN_{MS} in the resync message is concealed (using an XOR function) with an Anonymity Key (AK*) which is cryptographically derived from RAND received in the authentication vector and the unique key K for the user which is stored in the USIM. The AK* has the same length as SQN_{MS} (i.e. 48 bits), The AuC receives the resync message, generates the same Anonymity Key (AK*) and then strips the mask off to recover SQN_{MS}.

As described above, the USIM sends a resync message in response to receiving an authentication vector including a SQN when it is determined that the SQN provided by the AuC in the authentication vector is not ‘fresh’. As the resync message adopts the same RAND value as the received authentication vector and the Anonymity Key AK* used to conceal SQN_{MS} is determined by RAND and K and no other inputs, if an attacker, operating a false base station, sends the same authentication vector to the same device twice, both triggering resync messages, then the same AK* is used both times and the attacker can learn some information about SQN_{MS}. Such an attack is not easy. However, this possibility for attack has been described in a paper entitled ‘New Privacy Threat on 3G, 4G and Upcoming 5G AKA Protocols’ by Ravishankar Borgaonkar, Lucca Hirschi, Shinjo Park and Altaf Shaik, in Proceedings on Privacy Enhancing Technologies 2019. Moreover, protection of SQN during AKA re-synchronisations has been identified as a key issue #4.1 in 3GPP TR 33.846 V0.5.0 (see section 5.4) with solutions proposed in section 6.4 of this 3GPP document.

A solution described in section 6.4.1 of 3GPP TR 33.846 V0.5.0 adds MAC-S as an input parameter to the calculation of the Anonymity Key in the case of synchronisation failure for AKA. MAC-S is a 64-bit Message Authentication Code that is included in the resync messages sent as a response to the AuC and is like a digital signature that the AuC can check to make sure that the resync message is genuine. MAC-S is calculated with the following inputs: SQN_{MS}, K, RAND and AMF. AMF is a 16-bit Authentication Management Field, which takes on all 0s in the resync messages. As MAC-S is calculated using SQN_{MS}, this ensures that a fresh input is used for the calculation of the Anonymity Key in a re-synchronisation procedure and so the above described attack is not possible.

Another solution is described in section 6.4.2 of 3GPP TR 33.846 V0.5.0. In this solution, a symmetric encryption function is used to protect SQN_{MS} with input key of Anonymity Key in the case of synchronisation failure for AKA.

It is desirable to provide an improved solution to protect SQN_{MS} included in a response message to a network entity as part of an authentication protocol.

### SUMMARY

In accordance with different aspects of the invention, there are provided a method, a processing module, a communication device and a communication system as recited in the accompanying claims.

The method is performed in a processing module of a communication device and is for generating an encrypted sequence number for a response message to a network entity. In an example implementation, the method is performed as part of an authentication protocol for authentication between a user (of the communication device) and a communication network.

By encrypting, using a block cipher encryption function, the previously received sequence number with the sequence number encryption key having a length greater than 48 bits and with the block cipher encryption function being configured to generate the encrypted sequence number having the same number of bits as the previously received sequence number, the security of the encrypted sequence number is improved by using a longer encryption key whilst ensuring there is no impact on the protocols and interfaces between the communication device and the network compared to the known authentication protocols, such as the 3G AKA protocol as described above.

For example, as with the arrangement described above for the 3G AKA protocol where the SQN_{MS} in the resync message is concealed (using an XOR function) with an Anonymity Key (AK*) having the same length (i.e. 48 bits) as the SQN_{MS}, the encrypted sequence number provided by the processing module has the same number of bits as the previously received sequence number. Thus, with the encrypted sequence number having the same number of bits as the previously received sequence number, the functionality of the communication device is unchanged compared to the above described 3G protocol which uses the XOR function to conceal the SQN_{MS} in the resync message. Security is improved by using a sequence number encryption key of greater than 48 bits (e.g. 128 bits) compared to an encryption key of 48 bits. Furthermore, even if an attacker triggers two messages to be sent by the communication device with the same sequence number encryption key, the block cipher encryption function ensures that the encrypted sequence number in the response messages are different in a way that reveals no information to a potential attacker.

The block cipher encryption function may be a format-preserving encryption, FPE, function.

In an example, the range (e.g. a predetermined range) determined by reference to a value of a previously received sequence number is defined by:

SQN>SQN_{MS}, and [1]

SQN−SQN_{MS}<Δ [2]

Where SQN_{MS} is the previously received sequence number and SQN is the current sequence number and A is a predetermined threshold, for example determined by a network operator/provider, and is fixed according to an availability vs security trade-off.

In one example, the previously received sequence number is a previously received sequence number that has been accepted (e.g. verified) by the processing module and stored in the processing module.

The processing module may be configured to implement a Universal Subscriber Identity Module (USIM) application and may be implemented on a card such as the Universal Integrated Circuit Card (UICC).

The response message may be a synchronisation failure message sent by the communication device. The response message may be sent following receipt, by the communication device, of an authentication message including a current sequence number and a random number provided by the network entity. The synchronisation failure message may be sent as part of an authentication protocol, such as a 3GPP authentication protocol (e.g. 3G AKA protocol). The synchronisation failure message may be sent to facilitate resynchronisation of the sequence numbers between the network entity and the processing module.

### BRIEF DESCRIPTION OF THE DRAWINGS

A method, a processing module, a communication device and a communication system, in accordance with the disclosure, will now be described, by way of example only, with reference to the accompanying drawings in which:

FIG. 1 is a block schematic diagram of an example communication system.

FIG. 2 is a block schematic diagram of an example communication device.

FIG. 3 is a block schematic diagram of an example processing module.

FIG. 4 is a schematic and simplified diagram representing how elements for the synchronisation failure message are generated according to the 3G AKA protocol.

FIG. 5 is a flow diagram of an example method for generating an encrypted sequence number for a response message to a network entity.

FIG. 6 is a schematic and simplified diagram representing how the encrypted sequence number for the response message is generated in accordance with the method of FIG. 5.

FIG. 7 is a schematic and simplified diagram showing an example message flow between various entities in the communication system of FIG. 1.

FIG. 8 is a schematic representation of the circular relationship when MAC-S is used to generate an Anonymity Key, AK*, for masking SQN_{MS}.

### DETAILED DESCRIPTION OF THE DRAWINGS

In the following description, examples of the disclosure will be described with respect to a communication device operating within a communication network. The communication network may include a GSM communication system, a 3G communication system, such as an Universal Mobile Telecommunication System (UMTS), or a 4G communication system, such as a Long Term Evolution (LTE) communication system or a 5G communication system or any combinations thereof. It will however be appreciated that the present disclosure can be used in communication devices and networks other than wireless communication systems, such as in wired communication devices or any communication devices having the capability to communicate with another device in a network, such as a digital camera having a built-in modem, or an embedded modem/communications device for a car, or utility meters or similar devices.

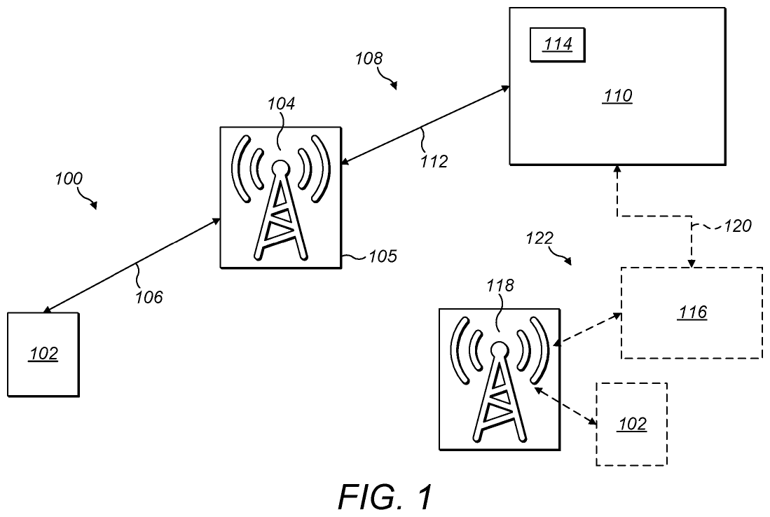

Referring firstly to FIG. 1, an example communication system 100 comprises a communication device 102 capable of communicating with a base station 104 through one or more wireless links 106. The wireless links may include one or more wireless links implemented using any suitable communication protocol or standard, or combination of communication protocols or standards, such as 3G, 4G, 5G. The base station 104 is part of a Radio Access Network (RAN) 105 (e.g. GSM/EDGE RAN (GERAN), Evolved Universal Terrestrial Radio Access Network (E-UTRAN), 5G New Radio RAN (5G NR RAN)) of a communication network 108. The base station 104 may be a base transceiver station (BTS), or an Evolved Node B (eNB) or a Next Generation Node B (gNodeB) or an access point or the like depending on the communication protocol or standard implemented by the communication network 108. In the example, shown in FIG. 1, the communication network 108 is a home network (HN) (also referred to as Home Environment (HE)) for the user of communication device 102 in communication with the RAN 105 via interface 112 and includes a core network 110. The home network 108 includes a network entity 114 in the core network 110. The network entity 114 may be an authentication entity for authenticating users/subscribers, such as an Authentication Centre (AuC) within a Home Location Register (HLR) of a 3G home network or a Home Subscriber Server (HSS) of a 4G home network or a AUthentication Server Function (AUSF) of a 5G home network or the like depending on the communication protocol or standard implemented by the communication network 108. In an example scenario when the communication device 102 is in a location where the corresponding home network 108 has no base station (as shown in FIG. 1 with the communication device 102 located in a position shown in dotted lines), the communication device 102 attaches to and communicates with a Serving Network (SN) 122 via a base station 118 of the SN 122. The core network 116 of the Serving Network 122 is coupled to the home network 108 via an interface 120 which may be based on the Internet Protocol (IP).

Although one communication device 102 and two base stations 104 and 118 is shown in FIG. 1, it will be appreciated that the communication system 100 typically comprises a plurality of communication devices and communication networks comprise a plurality of base stations. As will be apparent to a skilled person, FIG. 1 shows only the functional components of an exemplary communication system that are necessary for an understanding of the disclosure.

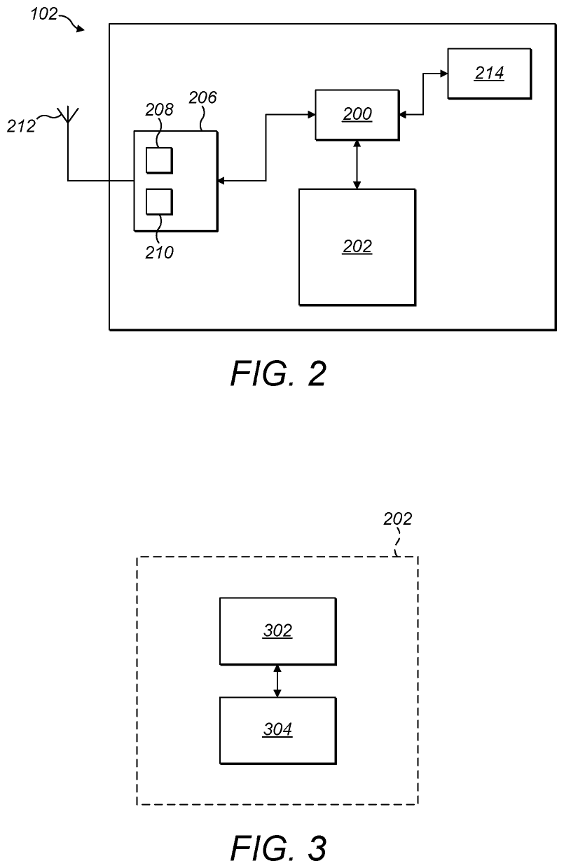

FIG. 2 is a block diagram of an example implementation of a communication device, such as the communication device 102 shown in FIG. 1. As will be apparent to a skilled person, FIG. 2 shows only the functional components of an exemplary communication device that are necessary for an understanding of the disclosure. The communication device may be a smart phone, a mobile phone, subscriber unit, user equipment, portable telephone, wireless video or multimedia device, a communication terminal, a personal digital assistant (PDA), a laptop computer, a modem card, an Internet of Things (IoT) device, a wired device or any communication device implementing a 3GPP authentication protocol, such as the Authentication and Key Agreement (AKA) protocol, such as the 3G AKA protocol as defined in the 3GPP technical specification 3GPP TS 33.102 V15.1.0 (2018-12). The 3GPP authentication protocol is a protocol for mutually authenticating a communication device (e.g. with a Universal Subscriber Identity Module (USIM) application) with a communication network, and establishing keys to protect subsequent communications between the communication device and the communication network. 4G and 5G systems use AKA protocols that are based on and similar to the above described 3G AKA protocol. In addition, AKA protocols similar to the 3G AKA protocol are also used in Extensible Authentication Protocol (EAP) mechanisms to secure point-to-point protocol authentication methods, wireless LAN internetworking, generic authentication architectures. For example, 4G defines 4G EPS-AKA and 5G defines 5G-AKA, EAP-AKA′ and EAP-TLS. It is therefore not intended that the disclosure be limited to the 3G AKA protocol as defined in the 3GPP technical specification 3GPP TS 33.102 V15.1.0 (2018-12).

In the following description, the communication device 102 will be referred to as User Equipment (UE).

The UE 102 comprises a processing unit 200 for carrying out operational processing for the UE 102, such as radio transmission and related functions. The UE 102 also has a communication section 206 for communicating via a wireless link with a base station (e.g. 104 or 118). The communication section 206 typically includes at least one antenna 212, receiver circuitry 208 and transmitter circuitry 210. The communication section 206 is coupled to processing unit 200.

The UE 102 may have a user interface (not shown) for providing an interface between the UE 102 and a user of the device, including elements such as a key pad, microphone, speaker, display screen.

The processing unit 200 may be a single processor or may comprise two or more processors carrying out the processing required for the operation of the UE 102. The number of processors and the allocation of processing functions to the processing unit 102 is a matter of design choice for a skilled person. The UE 102 also has a program memory 214 in which is stored data and programs containing processor instructions for the operation of the UE 102. The programs may contain a number of different program elements or sub-routines containing processor instructions for a variety of different tasks for the operation of the UE 102, such as for performing radio transmission and related functions. For example, the programs may contain instructions for processing data received at the receiver circuitry 208, such as signalling information (control plane data) and traffic data (user plane data) and for processing data, such as signalling information (control plane data) and traffic data (user plane data), for transmission by the transmitter circuitry 210.

The UE 102 further comprises a processing module 202 for implementing an authentication protocol in the UE 102 for authentication between the UE 102 (i.e. a user of the UE 102) and a communication network (e.g. mutual authentication). With reference now also to FIG. 3, the processing module 202 comprises memory 302 for storing a key and one or more processing elements 304 coupled to the memory 302. The key (K) stored in the memory 302 may be a unique key associated with a user and the key K is also stored in the network entity 114 (e.g. the authentication entity) of the home network 108. Other network specific information used for authentication, to identify the UE and to control access to a communication network, such as cryptographic keys to protect both signalling and user plane data, may be stored in the memory 302. In an example implementation, the processing module 202 is configured to implement a Universal Subscriber Identity Module (USIM) application. The USIM application is stored in the memory 302 and includes a number of different program elements or sub-routines containing instructions, which when executed by the one or more processing elements 304, cause the processing module 202 to perform operations implementing functions of the USIM application.

The processing module may be integrated into the UE 102 or may be removable. When the processing module 202 is removable, an interface (not shown) is coupled to the processing unit 200 for interfacing between the removable processing module 202 and the processing unit 200. The removable processing module may be a card or a smart card, such as a Subscriber Identify Module (SIM) card or a Universal Integrated Circuit Card (UICC). The UICC can run several applications such as the USIM application for a 3G network or other networks.

When the processing module 202 implements the USIM application, the processing module is part of the USIM domain of the UE 102 and the communication section 206, the processing unit 200 and the program memory 214 of the UE 102 are part of a Mobile Equipment Domain (ME) of the UE 102.

As discussed in the introduction, the 3G AKA protocol for authenticating a user for access to a 3G network is described in the 3GPP technical specification 3GPP TS 33.102 V15.1.0 (2018-12) and is a challenge-response protocol. Briefly and as discussed above, the 3G AKA protocol includes sending an authentication challenge (known as an authentication vector), created by an Authentication Centre (AuC) within the (HSS) or Home Location Register (HLR) in the home network, to the USIM application of the communication device. The authentication vector includes a 48-bit sequence number SQN. The communication device replies with an authentication response message when the authentication challenge is successfully received and verified by the USIM application or an authentication failure message with the cause of failure otherwise when verification is not successful. To verify the received SQN, the USIM application checks whether the received SQN of the received authentication vector is new (i.e. fresh). When the USIM application determines that the required SQN is not new (e.g. is too low compared to the SQNs received before) or otherwise suspicious (e.g. it may be too high as well as too low) but the authentication challenge is correct in all other respects, the USIM application rejects the received authentication vector and sends a synchronisation failure message (or resync message) back to the home network.

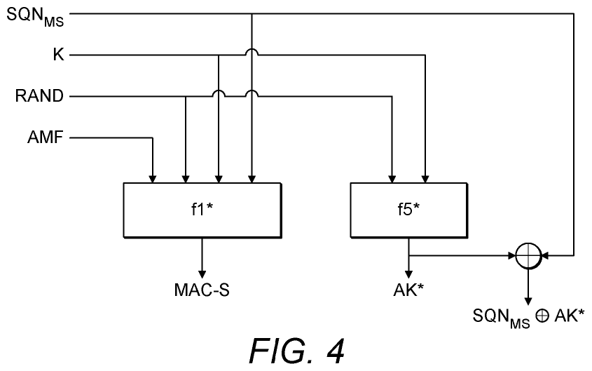

With reference now to FIG. 4, which shows how the resync message according to the 3GPP TS 33.102 V15.1.0 (2018-12) is constructed, the resync message includes MAC-S and SQN_{MS} ⊕AK*, where:
K is the user/subscriber-unique key held in both USIM and AuC
RAND is the 128-bit “random” input
SQN_{MS} is the highest value of SQN that the USIM has previously accepted
AMF is a 16-bit Authentication Management Field, which takes an all 0s value in these resync messages
MAC-S is the 64-bit Message Authentication Code for resync messages—like a digital signature that the AuC can check to make sure that the resynch message is genuine
AK* is the Anonymity Key
⊕ is an exclusive OR (XOR) function
f1* and f5* are functions defined in the 3GPP TS 33.102 V15.1.0 (2018-12)

The Anonymity Key AK* is therefore used to mask the SQN_{MS} value and has the same length as the SQN_{MS} value (i.e. 48 bits). The AuC receives the resync message, generates the same AK* value, and then strips the mask off again to recover SQN_{MS}, by computing (SQN_{MS} ⊕AK*) ⊕AK*=SQN_{MS}.

As discussed in the introduction, as the resync message adopts the same RAND value as the received authentication vector and the Anonymity Key AK* used to conceal SQN_{MS} is determined by RAND and K and no other inputs, if an attacker, operating a false base station, sends the same authentication vector to the same device twice, both triggering resync messages, then the same AK* is used both times and the attacker can learn some information about SQN_{MS} (e.g. the attacker learns the XOR of the two SQN_{MS} values).

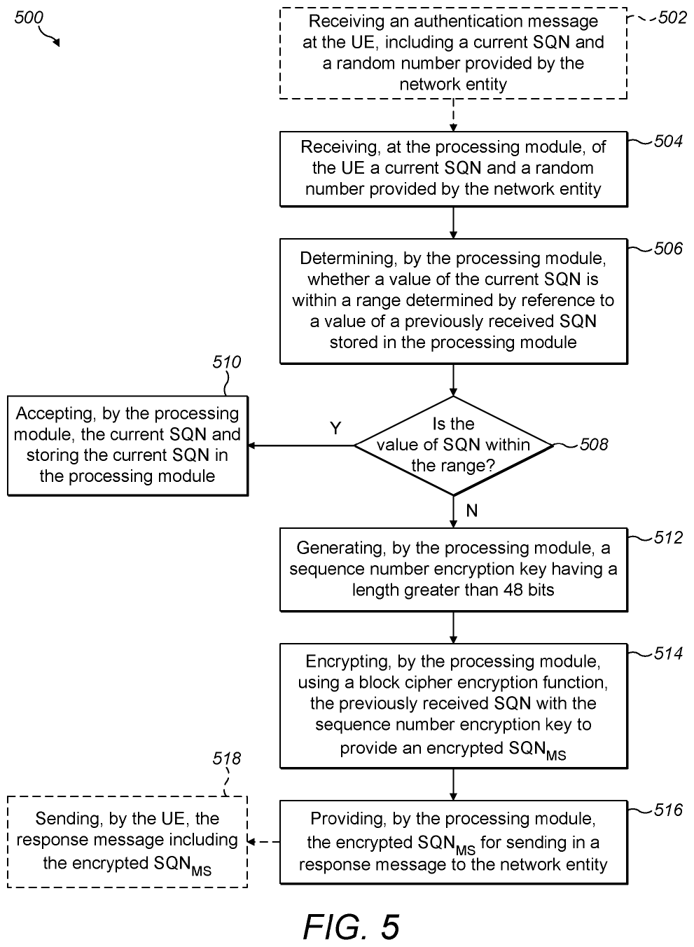

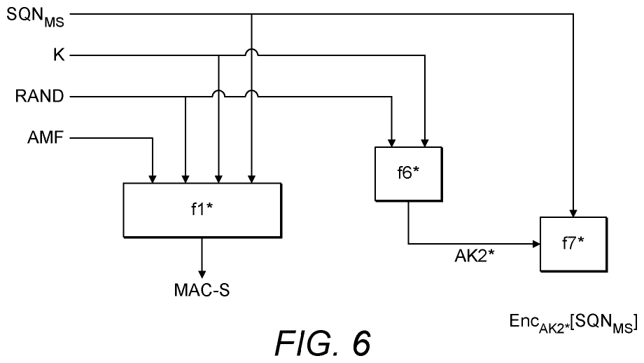

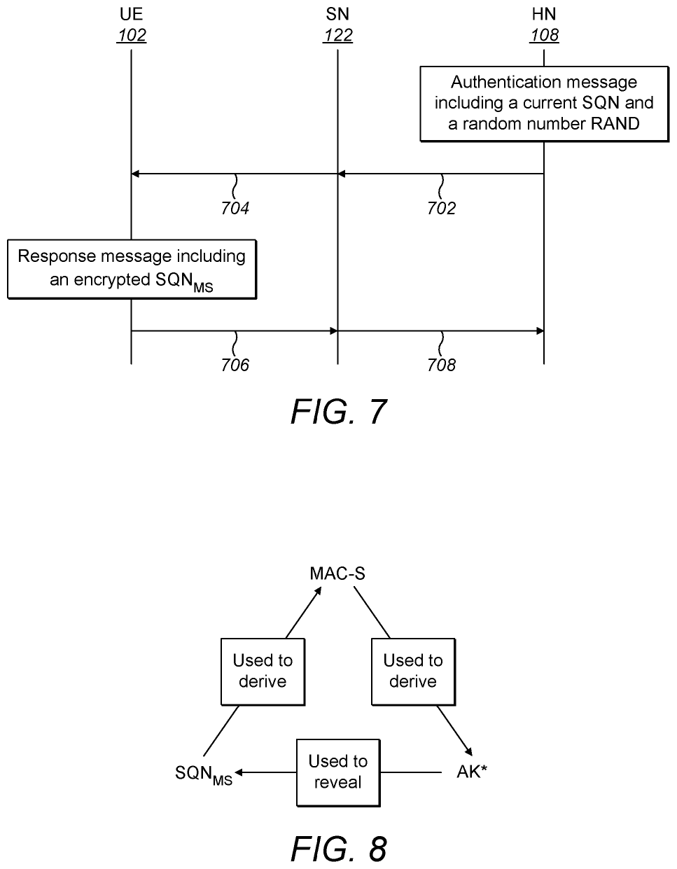

In order to prevent an attacker learning information about SQN_{MS} in such an attack, an example method for generating an encrypted sequence number for a response message to a network entity (e.g. as part of an authentication protocol for authentication between a user of the UE 102 and a communication network) in accordance with the disclosure is proposed and will now be described with reference also to FIGS. 5, 6 and 7, where FIG. 5 is a flow diagram of an example method 500 for generating an encrypted sequence number for a response message to a network entity, FIG. 6 is a simplified diagram representing how the encrypted sequence number for the response message is generated, and FIG. 7 is a simplified and schematic diagram showing an example message flow between various entities in the communication system 100. In FIG. 5, the steps shown in solid lines are performed by the processing module 202 (e.g. via the USIM application executing on the one or more processing elements 304) and the steps in dotted lines are performed at other parts of the UE 102 (e.g. by the ME domain of the UE).

At step 502, the UE 102 receives, for example at the receiving circuitry 208, an authentication message and the authentication message includes a current SQN and a random number (RAND) provided by the network entity 114 of the home network 108. As discussed above, the network entity 114 may be an authentication entity such as an AuC and the network entity 114 generates the authentication message (e.g. an authentication vector) which includes a random number (RAND) and a current sequence number (SQN) to be sent to the UE 102 in the authentication message. The network entity 114 normally increases the value of the current SQN by one each time it sends an authentication message. The current SQN provided by the network entity 114 may be a 48-bit SQN. The current SQN sent in the authentication message is masked by an Anonymity Key AK (which has the same length as the current SQN). The AK is cryptographically derived from the key K which is shared between the network entity 114 and the processing module 202 (e.g. the K is stored in the memory 302 of the processing module 202 and is stored in the network entity 114 and is a unique key associated with a user) and the random number RAND (which is included in the authentication message). As discussed above, in an example, the authentication message is also known as the authentication vector and may also include a Message Authentication Code (MAC).

In the example scenario when the UE 102 communicates with a SN 122 as discussed above with reference to FIG. 1, the UE 102 receives the authentication message from the HN 108 via the SN 122 as shown by the message flow 702 and 704 in FIG. 7.

The processing module 202 receives the current SQN and the RAND provided by the network entity 114, such as the authentication entity 114, of the home network 108 and received at the receiving circuitry 208, step 504. As part of the receiving step 504, the processing module 202 receives the masked current SQN and RAND, derives AK from the received RAND and K stored in the memory 302 using the same cryptographic function as used in the network entity 114 to generate AK and unmasks the masked current SQN using the generated AK to provide the current SQN. At step 506, the processing module 202 determines whether a value of the current sequence number SQN is within a range determined by reference to a value of a previously received sequence number stored in the memory 302. The previously received sequence number is a previously received sequence number (referred to in the following as SQN_{MS}) that has been accepted (e.g. verified) by the processing module 202 and may be one of a plurality of previously received sequence numbers accepted (e.g. verified) and stored in the processing module 202.

When the value of the current SQN is within the range determined by reference to a value of a previously received sequence number (branch Y of step 508), the processing module 202 accepts the current sequence number and stores the current sequence number in the processing module 202, step 510. Thus, an accepted previously received sequence number is a received current sequence number that has been determined previously to be within the range determined by reference to a value of a previously received sequence number (e.g. has been verified) and which has then been stored in the processing module 202 (e.g. in memory 302). If all authentication checks are successful (e.g. the MAC, the RAND and the SQN are received successfully and verified), the UE 102 generates a successful authentication response RES and sends the successful authentication response RES indicating that authentication is successful. If the UE 102 is attached to a SN 122, the successful authentication response RES is sent to the SN 122 and subsequent communications take place securely between the UE 102 and SN 122.

In an example, the range (e.g. a predetermined range) determined by reference to a value of a previously received sequence number is defined by:

SQN>SQN_{MS}, and [1]

SQN−SQN_{MS}<Δ [2]

Where SQN_{MS} is the previously received sequence number and SQN is the current sequence number and Δ is a predetermined threshold, for example determined by a network operator/provider, and is fixed according to an availability vs security trade-off.

In an alternative simplified example, the range (e.g. a predetermined range) determined by reference to a value of a previously received sequence number may be defined by SQN>SQN_{MS}, where SQN_{MS} is the previously received sequence number stored in the processing module 202 and SQN is the current sequence number.

The range determined by reference to a value of a previously received sequence number may be described as a sequence number management scheme. Example sequence number management schemes are provided in informative annex C of 3G TS 33.102 V15.1.0 (2018-12). However, network operators are free to choose their own sequence number management scheme if they so wish providing that the requirements on parameter lengths and out-of-order use that are described in section 6.3 of 3G TS 33.102 are met.

Annex C of 3G TS 33.102 specifies a generalised scheme for sequence number management and some suggested Profiles of the generalised scheme. These Profiles are intended to serve as references when specifying practical sequence number management schemes. A more sophisticated example scheme is based on Profile 2 from Annex C.3 of 3G TS 33.102 which is discussed below.

The AuC shall generate a 48-bit SQN as a concatenation of a 43-bit SEQ and a 5-bit IND. All values are unsigned binary numbers. The structure of SQN is illustrated below.

| | | | | | | | | | | | | | | | |
|---|---|---|---|---|---|---|---|---|---|---|---|---|---|---|---|
| 0 | 1 | 2 | 35 | 36 | 37 | 38 | 39 | 40 | 41 | 42 | 43 | 44 | 45 | 46 | 47 |

| | |
|---|---|
| SEQ (43 bits) | IND (5 bits) |

The USIM shall store a 32-element array of previously accepted sequence numbers. The 5-bit IND component of SQN extracted from the authentication vector (also referred to as authentication token (AUTN)) shall be used to index into the array. Each element of the array shall contain a 43-bit SEQ value. The initial value for all array elements shall be zero.

If the Message Authentication Code (referred to as (MAC-A)) on AUTN cannot be verified then the USIM shall indicate a network authentication failure (e.g. in a authentication failure message) to the terminal as described in section 6.3 of 3G TS 33.102. If MAC-A is verified then SQN shall be extracted from AUTN using the methods described in section 6.3 of 3G TS 33.102.

An SEQ from a particular SQN extracted from an AUTN shall be deemed fresh if it is greater than the SEQ stored in the array element indexed using the IND component of the same SQN. If a sequence number is deemed fresh then it shall overwrite the value that it was checked against in the array.

If SEQ is not deemed fresh then the resynchronisation procedure shall be invoked. As part of this procedure the USIM constructs a synchronisation failure message (or resync message) otherwise known as a resynchronisation token (AUTS) as specified in section 6.3 of 3G TS 33.102. The SQN_{MS} value in the AUTS token shall be constructed by setting the IND value to the received IND value, and the SEQ component to the value of the SEQ contained in the corresponding component of the array (indexed by received IND value).

Alternatively, and for simplicity, the SQN_{MS} value in the AUTS token shall be constructed by setting the SEQ component to the highest value of the SEQ contained in any element of the array. The IND component shall be set to a special “don't care” value. This mechanism simplifies the AuC logic, as the AuC only needs to maintain the state of a single SEQ component per USIM rather than 32 SEQ components per USIM.

When the value of the current SQN is not within the range determined by reference to a value of a previously received sequence number (branch N of step 508), the processing module 202 generates a sequence number encryption key derived from the random number RAND and the key K stored in the memory 302 of the processing module 202 with the sequence number encryption key having a length greater than 48 bits, step 512. The sequence number encryption key may have a length greater than 79 bits or may have a length in the range of 80 bits to 128 bits or may be at most 128 bits. In an example implementation, the sequence number encryption key is generated having a length 128 bits. This length of 128 bits provides increased security of the encrypted sequence number and is harder for an attacker to decrypt than say a key of 48 bits length. As shown in FIG. 6, the sequence number encryption key is generated by a function f6* which is a key derivation function that generates the sequence number encryption key AK2* having a length greater than 48 bits with RAND and K as the inputs to the function f6*. The key derivation function could be based on AES block cipher encryption, or based on a keyed hashed function, using the subscriber key K, or a further key derived from K. At step 514, the processing module 202 encrypts using a block cipher encryption function, the previously received sequence number with the sequence number encryption key to provide an encrypted sequence number, wherein the block cipher encryption function is configured to generate the encrypted sequence number having the same number of bits as the previously received sequence number. As shown in FIG. 6, the processing module 202 encrypts, using a block cipher encryption function f7*, the previously received sequence number SQN_{MS} (which is the previously received sequence number used in the determination step 506) with the sequence number encryption key AK2* to provide an encrypted sequence number Enc_{AK2*}[SQN_{MS}]. The processing module 202 provides the encrypted sequence number SQN_{MS} (e.g. Enc_{AK2*}[SQN_{MS}] for sending in a response message to the network entity 114, step 516.

In an example implementation, the block cipher encryption function is a format preserving encryption, FPE, function. This function may, for example, use a construction based around AES and a Feistel network: see https://en.wikipedia.org/wiki/Format-preservingencryption for an explanation of this, and for other constructions.

Using a block cipher function, such as a FPE function, configured to generate an encrypted sequence number having the same number of bits as the previously received sequence number means that no changes are required to the protocols and interfaces between the UE 102 and communication networks (e.g. the ME domain of the UE remains unchanged and only the USIM domain is changed). In other words, the functionality of the UE 102 (e.g. the ME domain of the UE) according to the disclosure is unchanged compared to the above described 3G protocol which uses the XOR function to conceal the SQN_{MS} in the resync message.

At step 518, the UE 102 sends the response message including the encrypted sequence number SQN_{MS}. In an example implementation where the message received at the UE 102 is an authentication message, the response message is a synchronisation failure message. For a 3G AKA implementation, the synchronisation failure message (also known as resync message) also includes a Message Authentication Code (e.g. MAC-S (see FIG. 6)). As discussed above, MAC-S is a 64-bit Authentication Code that is included in the resync messages sent as a response to the AuC and is like a digital signature that the AuC can check to make sure that the resync message is genuine. MAC-S is calculated using a function f1* defined in the 3GPP TS 33.102 V15.1.0 (2018-12) with the following inputs: SQN_{MS}, K, RAND and AMF. AMF is a 16-bit Authentication Management Field, which takes on all 0s in the resync messages.

The response message is sent to the network entity 114 (e.g. via the home network 108 or via the SN 122 as shown by the messages 706, 708 in FIG. 7). The network entity receives the response message, generates the same Anonymity Key (AK2*) as used by the processing module 202 from the RAND and K stored in the network entity 114 using the same cryptographic function f7* as used in the processing module 202 and decrypts the encrypted sequence number Enc_{AK2*}[SQN_{MS}] using the generated AK2* to provide the previously received and stored sequence number SQN_{MS}. This number is then stored in the network entity 114 and used by the network entity to create the current sequence number SQN for future authentication messages to be sent to the UE 102 (e.g. for the next authentication message the sequence number SQN_{MS} stored in the network entity is increased by one) to ensure the processing module 202 accepts a current SQN in future authentication messages.

With reference to the terminology used in the introduction, the processing module 202 determines that the received current SQN is not ‘new’ or not ‘fresh’ (e.g. is too low compared to the SQN previously received) or otherwise suspicious (e.g. it may be too high as well as too low) when the value of the current SQN is not within the range and in response, the UE 102 sends a response message (e.g. synchronisation failure message) indicating that synchronisation of the SQN between the network entity 114 and the processing module 202 is lost. The received SQN may be too low in the event of accidental reset of the HLR (where all SQN values are reset to 0, e.g. due to a software fault) or a change in HLR (e.g. migration between HLRs or fallover to a different HLR instance in a load-balanced network). The received SQN may be too high if a communication device has been detached from a network for a long period of time and the HLR has generated a large number of authentication vectors in the interval.

By encrypting, using a block cipher encryption function, the previously received sequence number with the sequence number encryption key having a length greater than 48 bits and with the block cipher encryption function being configured to generate the encrypted sequence number having the same number of bits as the previously received sequence number, the security of the encrypted sequence number is improved by using a longer encryption key whilst ensuring there is no impact on the protocols and interfaces between the communication device and communication networks compared to the known authentication protocols, such as the 3G AKA protocol as described above. Furthermore, even if an attacker triggers two messages to be sent by the communication device with the same sequence number encryption key, the block cipher encryption function ensures that the encrypted sequence number in the response messages are different in a way that reveals no information to a potential attacker.

As discussed in the introduction, a solution to a possible attack described in section 6.4.1 of 3GPP TR 33.846 V0.5.0 adds MAC-S as an input parameter to the calculation of the Anonymity Key in the case of synchronisation failure for AKA. Thus, with this solution, when receiving the message, the AuC uses the received MAC-S to derive AK*; then uses AK* to reveal SQN_{MS}; then uses SQN_{MS} to compute the correct value of MAC-S, and check that the received MAC-S was correct. This is therefore a circular relationship as shown in FIG. 8. In the disclosed method and processing module, the sequence number encryption key (AK2*) is derived from the random number (RAND) and the key (K) stored in the processing module (e.g. using the function f6* as indicated in FIG. 6). The sequence number encryption key AK2* used to encrypt the previously received sequence number is not derived from MAC-S. By encrypting, using a block cipher encryption function, the previously received sequence number with the sequence number encryption key which is derived from the key K and random number RAND and not from MAC-S, the disclosed method and processing module avoids a circularity with using MAC-S (e.g. as shown in FIG. 8) which circularity makes the security of a protocol harder to analyse.

In the foregoing description of the disclosure, reference has been made to particular examples. It will, however, be evident that various modifications and changes may be made to the description without departing from the scope of the invention as set forth in the appended claims.

Examples useful for understanding the disclosure are set out in the following clauses:

Clause 1. A processing module for a communication device, the processing module comprising: memory for storing a key; and one or more processing elements coupled to the memory and configured to: receive a current sequence number and a random number provided by a network entity; determine whether a value of the current sequence number is within a range determined by reference to a value of a previously received sequence number stored in the memory; when the value of the current sequence number is not within the range determined by reference to the value of the previously received sequence number: generate a sequence number encryption key derived from the random number and the key stored in the memory, the sequence number encryption key having a length greater than 48 bits; encrypt using a block cipher encryption function, the previously received sequence number with the sequence number encryption key to provide an encrypted sequence number, wherein the block cipher encryption function is configured to generate the encrypted sequence number having the same number of bits as the previously received sequence number; provide the encrypted sequence number for sending in a response message to the network entity.

Clause 2. The processing module of clause 1, wherein the block cipher encryption function is a format-preserving encryption, FPE, function.

Clause 3. The processing module of clause 1 or clause 2, wherein the previously received sequence number is a previously received sequence number that has been accepted by the processing module and stored in the processing module.

Clause 4. The processing module of any one of clauses 1 to 3, wherein the sequence number encryption key has a length of 128 bits or at most 128 bits.

Clause 5. The processing module of any one of clauses 1 to 4, wherein the one or more processing elements are configured to: when the value of the current sequence number is within the range, accept the current sequence number and store the current sequence number in the memory.

Clause 6. The processing module of any one of the preceding clauses, wherein the previously received sequence number is one of a plurality of previously received sequence numbers accepted and stored in the processing module.

Clause 7. A communication device, comprising: receiver circuitry configured to receive a message including a current sequence number and a random number, the current sequence number and the random number provided by a network entity; the processing module of any one of the preceding clauses, the processing module being coupled to the receiver circuitry, the one or more processing elements of the processing module being configured to receive the current sequence number and the random number included in the message received by the receiver circuitry; transmitter circuitry coupled to the processing module, the transmitter circuitry being configured to send the response message to the network entity, the response message including the encrypted sequence number.

Clause 8. The communication device of clause 7, wherein the received message is an authentication message and the response message is a synchronisation failure message.

Clause 9. A communication system, comprising: a communication network including a network entity; and a communication device of clause 7 or clause 8 configured to communicate with the communication network.

Clause 10. A method, comprising: receiving, at a processing module of a communication device, a current sequence number and a random number provided by a network entity; determining, by the processing module, whether a value of the current sequence number is within a range determined by reference to a value of a previously received sequence number stored in the processing module; when the value of the current sequence number is not within the range determined by reference to the value of the previously received sequence number: generating, by the processing module, a sequence number encryption key derived from the random number and a key stored in the processing module, the sequence number encryption key having a length greater than 48 bits; encrypting, by the processing module, using a block cipher encryption function, the previously received sequence number with the sequence number encryption key to provide an encrypted sequence number, wherein the block cipher encryption function is configured to generate the encrypted sequence number having the same number of bits as the previously received sequence number; providing, by the processing module, the encrypted sequence number for sending in a response message to the network entity.

Clause 11. The method of clause 10, wherein the block cipher encryption function is a format-preserving encryption, FPE, function.

Clause 12. The method of clause 10 or clause 11, wherein the previously received sequence number is a previously received sequence number that has been accepted by the processing module and stored in the processing module.

Clause 13. The method of any one of clauses 10 to 12, wherein the sequence number encryption key has a length of 128 bits or at most 128 bits.

Clause 14. The method of any one of clauses 10 to 13, further comprising when the value of the current sequence number is within the range, accepting, by the processing module, the current sequence number and storing the current sequence number in the processing module.

Clause 15. The method of any one of clauses 10 to 14, wherein the previously received sequence number is one of a plurality of previously received sequence numbers accepted and stored in the processing module.

Clause 16. The method of any one of clauses 10 to 15, further comprising sending, by the communication device, the response message including the encrypted sequence number.

Clause 17. The method of any one of clauses 10 to 16, further comprising receiving, by the communication device, an authentication message including a current sequence number and a random number provided by the network entity.

Clause 18. The method of clauses 16 and 17, wherein the response message sent by the communication device is a synchronisation failure message.

Clause 19. A communication device configured to perform the steps of the method of any one of clauses 10-19.

1. A processing module for a communication device, the processing module comprising:
memory storing a key; and
one or more processing elements coupled to the memory and configured to:
receive a current sequence number and a random number provided by a network entity;
determine whether a value of the current sequence number is within a range determined by reference to a value of a previously received sequence number stored in the memory;
when the value of the current sequence number is not within the range determined by reference to the value of the previously received sequence number:
generate a sequence number encryption key derived from the random number and the key stored in the memory, the sequence number encryption key having a length greater than 48 bits;
encrypt using a block cipher encryption function, the previously received sequence number with the sequence number encryption key to provide an encrypted sequence number, wherein the block cipher encryption function is configured to generate the encrypted sequence number having the same number of bits as the previously received sequence number;
provide the encrypted sequence number for sending in a response message to the network entity.

2. The processing module of claim 1, wherein the block cipher encryption function is a format-preserving encryption, FPE, function.

3. The processing module of claim 1 or claim 2, wherein the previously received sequence number is a previously received sequence number that has been accepted by the processing module and stored in the processing module.

4. The processing module of any one of claims 1 to 3, wherein the sequence number encryption key has a length of 128 bits or at most 128 bits.

5. The processing module of any one of claims 1 to 4, wherein the one or more processing elements are configured to:
when the value of the current sequence number is within the range, accept the current sequence number and store the current sequence number in the memory.

6. The processing module of any one of the preceding claims, wherein the previously received sequence number is one of a plurality of previously received sequence numbers accepted and stored in the processing module.

7. A communication device, comprising:
receiver circuitry configured to receive a message including a current sequence number and a random number, the current sequence number and the random number provided by a network entity;
the processing module of any one of the preceding claims, the processing module being coupled to the receiver circuitry, the one or more processing elements of the processing module being configured to receive the current sequence number and the random number included in the message received by the receiver circuitry;
transmitter circuitry coupled to the processing module, the transmitter circuitry being configured to send the response message to the network entity, the response message including the encrypted sequence number.

8. The communication device of claim 7, wherein the received message is an authentication message and the response message is a synchronisation failure message.

9. A communication system, comprising:
a communication network including a network entity; and
a communication device of claim 7 or claim 8 configured to communicate with the communication network.

10. A method, comprising:
receiving, at a processing module of a communication device, a current sequence number and a random number provided by a network entity;
determining, by the processing module, whether a value of the current sequence number is within a range determined by reference to a value of a previously received sequence number stored in the processing module;
when the value of the current sequence number is not within the range determined by reference to the value of the previously received sequence number:
generating, by the processing module, a sequence number encryption key derived from the random number and a key stored in the processing module, the sequence number encryption key having a length greater than 48 bits;
encrypting, by the processing module, using a block cipher encryption function, the previously received sequence number with the sequence number encryption key to provide an encrypted sequence number, wherein the block cipher encryption function is configured to generate the encrypted sequence number having the same number of bits as the previously received sequence number;
providing, by the processing module, the encrypted sequence number for sending in a response message to the network entity.

11. The method of claim 10, wherein the block cipher encryption function is a format-preserving encryption, FPE, function.

12. The method of claim 10 or claim 11, wherein the previously received sequence number is a previously received sequence number that has been accepted by the processing module and stored in the processing module.

13. The method of any one of claims 10 to 12, wherein the sequence number encryption key has a length of 128 bits or at most 128 bits.

14. The method of any one of claims 10 to 13, further comprising when the value of the current sequence number is within the range, accepting, by the processing module, the current sequence number and storing the current sequence number in the processing module.

15. The method of any one of claims 10 to 14, further comprising:
receiving, by the communication device, an authentication message including a current sequence number and a random number provided by the network entity; and
sending, by the communication device, the response message including the encrypted sequence number.
